(19) United States
(12) Patent Application Publication
(10) Pub. No.: US 2005/0114718 A1
(43) Pub. Date: May 26, 2005

(54) Electric device attachable to board having electric circuit and control method thereof

(75) Inventor: Nobuyasu Ito, Ibaraki (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/992,983

(22) Filed: Nov. 19, 2004

(30) Foreign Application Priority Data
Nov. 21, 2003 (JP) 2003-392376

(51) Int. Cl. G06F 1/26

(52) U.S. Cl. 713/300

(57) ABSTRACT

An electric device attachable to option boards and a method for controlling the same. The electric device includes option connectors for connecting to the option boards, a power unit which supplies a voltage for operating a circuit on the option boards, readers/writers which read information for determining whether or not the option boards are compatible with the electric device based on RFID tags added to the option boards, and a backup control portion which determines whether or not the option boards are compatible with the electric device based on the information read by the readers/writers. When the backup control portion determines that the option boards are compatible with the electric device, the power unit supplies the voltage to the circuit. When the backup control portion determines that the option boards are not compatible with the electric device, the power unit prevents the supply of the voltage to the circuit.

### BACKGROUND OF THE INVENTION

1. Field of the Invention

The present invention relates to an electric device attachable to a board having an electric circuit and a control method thereof.

2. Description of the Related Art

It is well-known that a conventional electric device such as a personal computer (PC) or an MFP (multi-function printer) includes a main controller board having a plurality of slots for accommodating therein an option connector for an option board and future functional expansion. In this case, generally, the slots (connectors) have various shapes so as to correctly attach the option board to a predetermined slot (connector).

However, pre-setting of the plurality of the variously-shaped slots (connector) results in an increase in costs. Japanese Patent Laid-Open No. 8-235100 discloses a plurality of slots (connectors) are similarly shaped and an option board attached to the slots (connectors) to turn on the main power of a power supply for entirely driving the device. Identification data on the option board is read from the option board of the device for determining whether or not the option board is correctly attached to the corresponding slot (connector).

With the above-mentioned structure for reading the identification data on the option board while the main power is turned on, when the option board is erroneously attached to the option connector which is not electrically compatible therewith, there can occur a hazard of an over-voltage or over-current flow to the option connector and the option board for a predetermined time. Therefore, the electric device may break as well as become non-operational or operate erroneously. The same inconvenience is caused not only in the option board but also in the attachment of plate-shaped devices (referred to as option boards in the present specification) such as an expansion board or a PC card to the option connector.

### SUMMARY OF THE INVENTION

The present invention is directed to an improved electric device attachable to a board that can correctly determine whether or not the board is compatible with the electric device without supplying a voltage for operating the board.

The present invention is also directed to a control method of the above electric device.

According to one aspect of the present invention, there is provided an electric device attachable to a board having an electric circuit and a memory. The electric device includes a connector unit configured to connect to the board; a first voltage-supply unit configured to supply a first voltage for, operating the electric circuit; a reading unit configured to read, from the memory, first determining information for determining whether or not the board is compatible with the electric device; a determining unit configured to determine whether or not the board is compatible with the electric device based on the first determining information read by the reading unit; and a control unit configured to control the first voltage-supply unit to supply the first voltage to the electric circuit responsive to the determining unit determining that the board is compatible with the electric device, and to prevent the first voltage-supplying unit from supplying the first voltage to the electric circuit responsive to the determining unit determining that the board is not compatible with the electric device.

According to another aspect of the present invention, there is provided a control method of an electric device attachable to a board having an electric circuit and a memory. The control method of the electric device includes a reading step of reading, from the memory, first determining information for determining whether or not the board is compatible with the electric device; a determining step of determining whether or not the board is compatible with the electric device based on the first determining information read in the reading step; a first control step of controlling the supply of a first voltage for operating the electric circuit responsive to determining in the determining step that the board is compatible with the electric device; and a second control step of preventing the supply of the first voltage responsive to determining in the determining step that the board is not compatible with the electric device.

Further, features and advantages of the present invention will become apparent from the following description of the embodiments with reference to the attached drawings.

### BRIEF DESCRIPTION OF THE DRAWINGS

The accompanying drawings, which are incorporated in and constitute a part of the specification, illustrate an embodiments of the invention and, together with the description, serve to explain the principles of the invention.

FIG. 1 is a block diagram of a control portion of an MFP device according to the present invention.

FIG. 2 is a block diagram of an RFID tag.

FIG. 3 is a block diagram of a reader/writer.

FIG. 4 is a diagram showing board information.

FIG. 5 is a flowchart showing the operation and the processing for attaching an option board.

FIG. 6 is a flowchart showing the operation and the processing for obtaining the latest board information in the attachment of the option board.

FIG. 7 is a flowchart showing the detail of the control for power supply.

FIG. 8 is a time chart showing the control for power supply.

FIG. 9 is a circuit diagram of a DC power unit and a backup control portion.

FIG. 10 is a diagram of a signal driving system of an option board controller.

### DESCRIPTION OF THE EMBODIMENTS

The present invention will now be described in detail with reference to the drawings showing an embodiment thereof. In the drawings, elements and parts which are identical throughout the views are designated by identical reference numerals, and duplicate description thereof is omitted.

Hereinbelow, an embodiment of the present invention will be described.

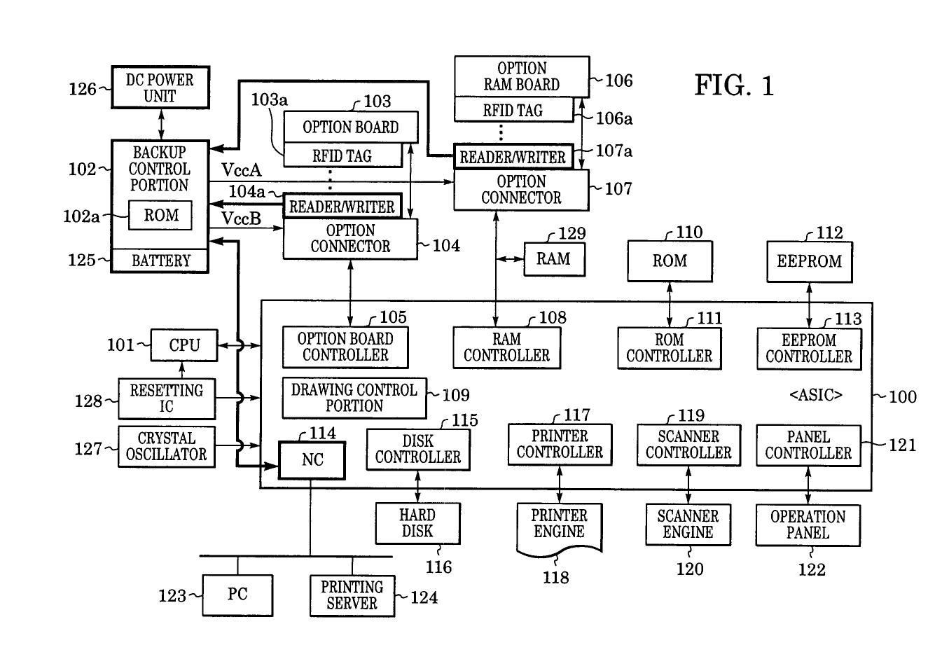

FIG. 1 is a block diagram of a printing device (digital complex machine: MFP device) according to one embodiment of the present invention.

Referring to FIG. 1, a main controller board (not shown) includes: an ASIC (Application Specified IC) 100, a CPU 101, a backup control portion 102, an option connector 104 for an option board 103, an option connector 107 for an option RAM board 106, a ROM 110, an EEPROM 112, a DC power unit 126, a crystal oscillator 127, a resetting IC 128, and a RAM 129.

The CPU 101 entirely controls the MFP device. The ROM 110 stores therein various font data and booting programs. The EEPROM 112 stores therein various setting information on the MFP device. In the RAM 129, a system program (OS) stored in a hard disk 116 which will be described later and an application program are processed under the control of the CPU 101. The RAM 129 is used as a work area of the CPU 101.

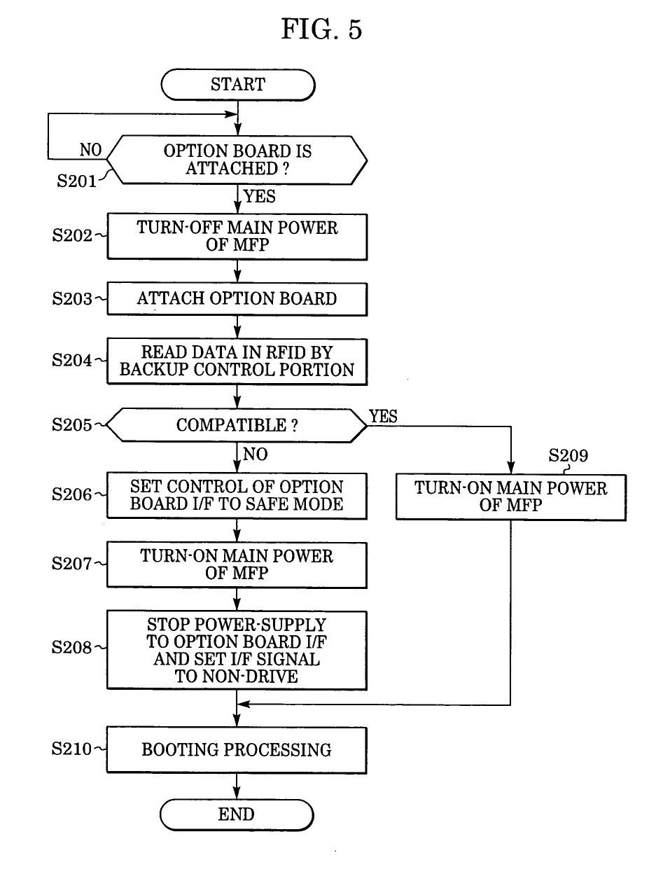

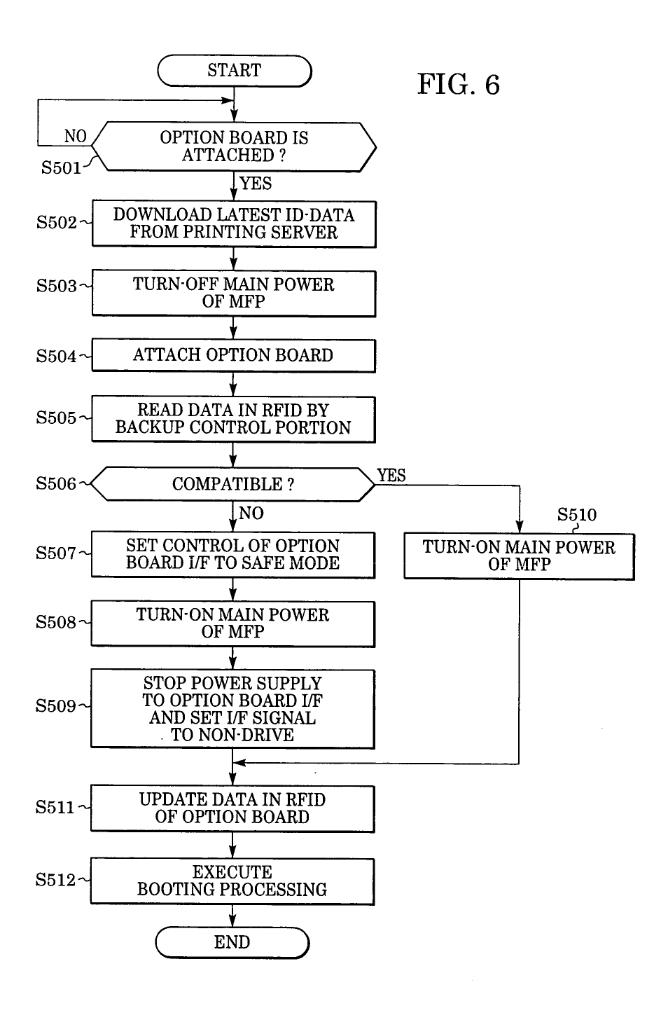

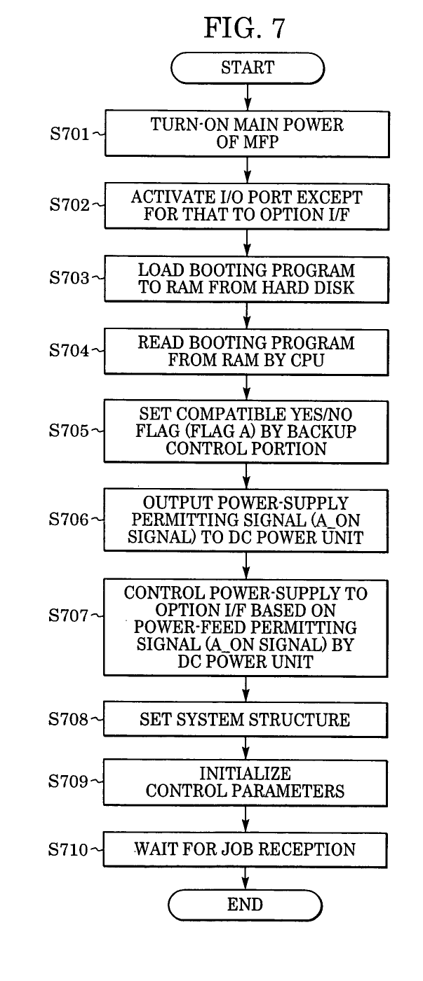

The backup control portion 102 performs a predetermined processing by a voltage supplied from a battery 125 (battery) both in a power-off state and in a sleeping state. The predetermined processing includes processing in steps S204 to S206 and S208 in the flowchart of FIG. 5, which will be described later, steps S505 to S507 and S509 in the flowchart of FIG. 6, and steps S705 and S706 in the flowchart of FIG. 7. The application program in the predetermined processing is stored in a ROM 102a incorporated in the backup control portion 102.

RFID (Radio Frequency Identification) tags 103a and 106a are added to the option board 103 and the option RAM board 106. Readers/writers 104a and 107a are arranged near (slots of) option connectors 104 and 107 to access the RFID tags 103a and 106a. Incidentally, the readers/writers 104a and 107a may be directly added to the slots which accommodate therein the option connectors 104 and 107 therein. An electric circuit is arranged on the option board 103 and the option RAM board 106 to execute a desired operation by a voltage supplied from the DC power unit 126 of a printing device.

The ASIC 100 incorporates therein an option board controller 105 which controls the input/output to/from the option board 103, a RAM controller 108 which controls access to the option RAM board 106 and the RAM 129, a drawing control portion 109 which rasterizes data as a printing target, a ROM controller 111 which controls access to the ROM 110, an EEPROM controller 113 which controls access to the EEPROM 112, a network controller (NC) 114 which controls input/output to/from a network, a disk controller 115 which controls access to the hard disk 116, a printer controller 117 which controls printing control of a printer engine 118, a scanner controller 119 which controls scanning operations of a scanner engine 120, and a panel controller 121 which controls input/output to the DC power unit 126.

A personal computer (PC) 123 and a printing server 124 are connected to the NC 114 via the network. The power from the battery 125 is supplied to the backup control portion 102, the readers/writers 104a and 107a, the NC 114, and the DC power unit 126. The DC power unit 126 functions as a main power supply for entirely driving the MFP device.

The number of option connectors for option board may be arranged in addition to the controller board or another board. Further, except for the boards, an option connector for the option board or the like such as an expansion board and a PC card may be arranged. Incidentally, according to the embodiment, the electric specification of the plurality of option connectors is the same.

RFID Tag

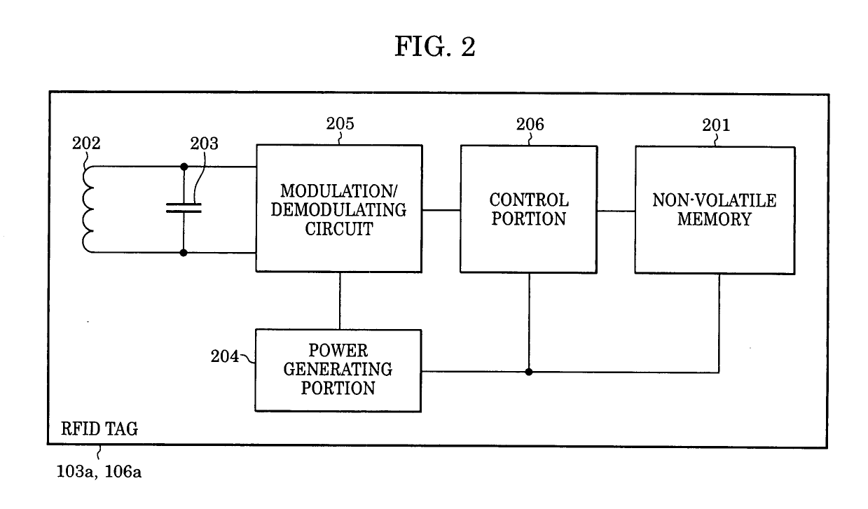

FIG. 2 is a block diagram of the RFID tags 103a and 106a. The RFID tags 103a and 106a are referred to as non-contact ICs or data carriers for communicating data to the reader/writer by radio (that is, non-contact state). According to the embodiment, a label-type RFID tag is employed and a non-contact IC incorporating therein the following devices is adhered in the label-type RFID.

The RFID tags (non-contact ICs) 103a and 106a includes a non-volatile memory 201, an antenna portion 202 for receiving and transmitting electric waves, a resonant condenser portion 203, a power generating portion 204 which smoothly adjusts current flow, a modulating/demodulating circuit 205 which modulates and demodulates the electric waves, and a control portion 206. The RFID tags 103a and 106a do not include a power supply, such as a battery, and generate dielectric power based on the electric waves supplied from the readers/writers.

The antenna portion 202 forms a resonant circuit by combining the resonant condenser portion 203. As will be described later, the readers/writers 104a and 107a continuously generate electric waves (AC magnetic field) for generating the power. The RFID tags 103a and 106a are moved close to the readers/writers 104a and 107a and then the dielectric current is generated by an electromagnetic guiding operation in the resonant circuit in the RFID tags 103a and 106a. The dielectric current is output to the power generating portion 204. The power generating portion 204 adjusts the input dielectric current to make it smooth, generates the power of a predetermined voltage, and supplies the generated power to the non-volatile memory 201, the control portion 206, and the modulating/demodulating circuit 205. The control portion 206 entirely controls the RFID tags 103a and 106a.

The readers/writers 104a and 107a simultaneously send an electric wave signal of various data as well as an electric wave signal for generating the power. The electric wave signal of the data is demodulated by the modulating/demodulating circuit 205, and is written to the non-volatile memory 201 under the control of the control portion 206. The control portion 206 reads the data from the non-volatile memory 201, the modulating/demodulating circuit 205 demodulates the read data, and the modulated data is sent as an electric wave signal via the antenna portion 202.

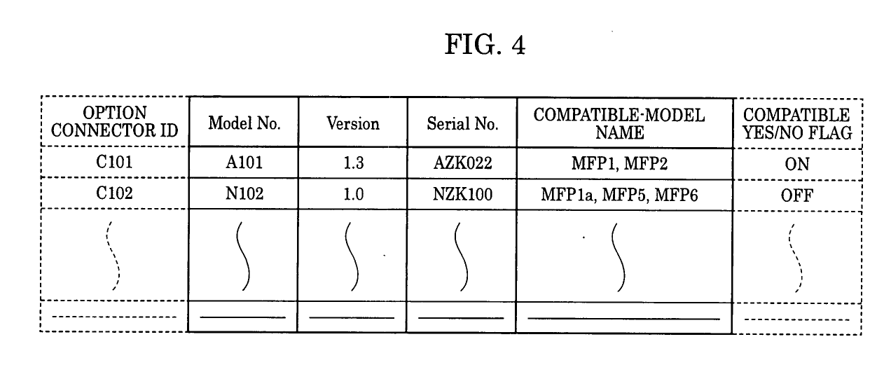

As shown by a portion surrounded by a solid line in FIG. 4, the non-volatile memory 201 of the RFID tags 103a and 106a records therein, as board information on the option board 103 or the option RAM board 106 additionally having the RFID tags 103a and 106a: ID information (identification information) such as model number indicating the type of option board, version number, and serial number; and ID information such as a model name (number) indicating the type of MFP device which is compatible, that is, electrically compatible with the option board.

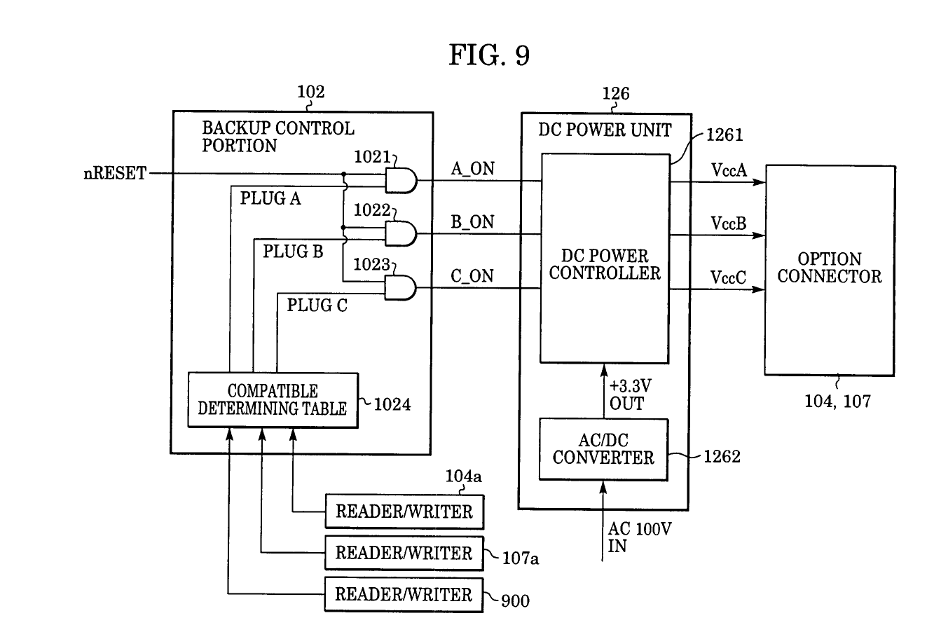

A compatible YES/NO flag surrounded by a broken line on the right in FIG. 4 indicates an information index of a compatible determining table 1024 (refer to FIG. 9) which is formed in a RAM (not shown) of the backup control portion 102. That is, the compatible determining table 1024 registers therein the ID information indicating the type of option boards which is electrically compatible with the option connectors 104 and 107 arranged to the MFP device, the ID information indicating the type of MFP device, and the compatible YES/NO flag. Incidentally, the compatible YES/NO flag is set after determining whether or not it is compatible.

The backup control portion 102 collates the ID information read by the readers/writers 104a and 107a from the non-volatile memory 201 of the RFID tag 103a or 106a with the ID information in the compatible determining table, thereby determining the electric compatibility between the option board and the option connector to which the option board is attached. The RFID tag 103a or 106a can add other information such as an operating power voltage, compatible type name, and an operating speed (setting values of the frequency level and the weight level in the bus access).

The RFID tag (non-volatile memory) added to the option board may record any one of the ID information indicating the type of option board, the ID information indicating the type of MFP device which is electrically compatible with the option board, and the ID information indicating the type of option connector which is electrically compatible with the option board (refer to a portion surrounded by a broken line on the left in FIG. 4). As mentioned above, upon recording, to the RFID tag, only the ID information indicating the type of option board or the ID information indicating the type of MFP device which is electrically compatible with the option board, if a plurality of types of option connectors are arranged to the MFP device, the electric specification of the option board is the same. Upon recording, to the RFID tag, only the ID information indicating the type of the option connector which is electrically compatible with the option board, if the plurality of types of the option connectors having the different specifications are arranged to the MFP device, the advantage is obtained according to the present invention.

Upon recording to the RFID tag only the ID information indicating the type of option board as mentioned above, the compatible determining table 1024 may register the ID information indicating the type of option board which is electrically compatible with the option connector arranged to the MFP device. Further, upon recording to the RFID tag only the ID information indicating the type of MFP device which is electrically compatible with the option board, the compatible determining table 1024 may register the ID information indicating the type of MFP device. Furthermore, upon recording to the RFID tag the ID information indicating the type of option connector which is electrically compatible with the option board, the compatible determining table 1024 may register the ID information indicating the type of option connector arranged to the MFP device.

Reader/Writer

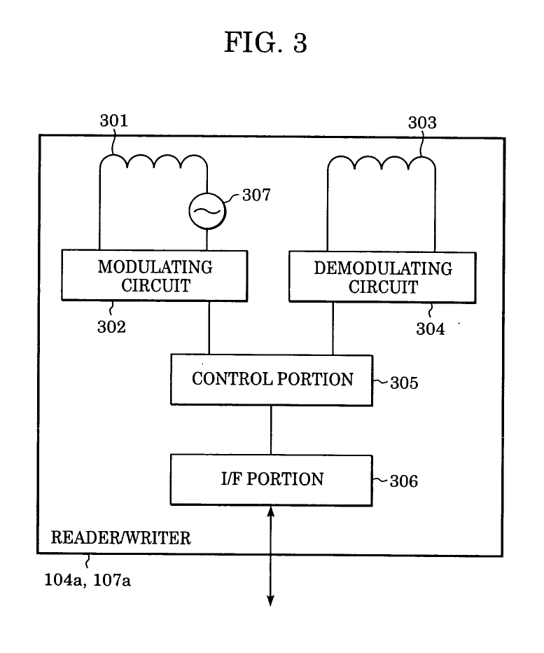

FIG. 3 is a block diagram showing the structure of the readers/writers 104a and 107a. The readers/writers 104a and 107a include a sending antenna portion 301 which sends the electric wave signal, a modulating circuit 302 which modulates a data signal sent from the sending antenna portion 301, a receiving antenna portion 303 which receives the electric wave signal, a demodulating circuit 304 which demodulates the electric wave signal received by the receiving antenna portion 303, an I/F portion 306 which communicates with an upper device (security server 103 according to the embodiment), and a control portion 305. The control portion 305 controls the sending antenna portion 301, the modulating circuit 302, the receiving antenna portion 303, the demodulating circuit 304, and the I/F portion 306. An AC power supply 307 is connected to generate the electric waves for generating the above power.

The control portion 305 modulates the electric waves for supplying the power by using the modulating circuit 302 and the sent data in accordance with an instruction from the security server 103, and transmits the electric waves via the sending antenna portion 301. Further, the control portion 305 demodulates the electric wave signal received by the receiving antenna portion 303 by using the demodulating circuit 304, and then converts the demodulated signal which can be handled as the data signal.

Next, a description is given of the option and the processing for attaching the option board (including the option RAM board) with reference to a flowchart shown in FIG. 5.

Upon attaching the option board to the option connector (in step S201), the user turns off the main power of the MFP device, namely, the commercial power of the DC power unit 126 so as to prevent electric breakage due to the insertion/pull-out of the option board in the power-on state (in step S202). Then, the option board is attached to the option connector (in step S203).

Under the control of the backup control portion 102, the reader/writer arranged near the option connector continuously performs the accessing operation to the RFID tag. The option board is attached to the option connector and then the reader/writer near the option connector reads the ID information (board information) from the RFID tag added to the option board, and transfers the ID information to the backup control portion 102 (in step S204). In this case, since a read command is cyclically issued to the reader/writer, the backup control portion 102 automatically recognizes, based on the issuing situation of the read command, the reader/writer corresponding to which option connector among the plurality of option connectors, namely, which ID information is read from the option board.

The backup control portion 102 collates the ID information read by the reader/writer with the ID information on the compatible determining table 1024 and thus determines whether or not the option board attached to the option connector corresponding to the reader/writer is electrically compatible with the option connector (in step S205). If YES in step S205, the backup control portion 102 sets-on the compatible YES/NO flag corresponding to the option connector on the compatible determining table 1024. If NO in step S205, the backup control portion 102 sets-off the compatible YES/NO flag.

The user attaches the option board to the option connector in step S203 and thereafter turns on the main power of the MFP device (in steps S207 and S209).

If the option board attached to the option connector is not electrically compatible with the option connector, the backup control portion 102 completes the processing for setting the option board I/F, namely, the attached option connector to the safe mode (in step S206) so as to prevent electric breakage of the electric device in the MFP device before the user turns on the main power of the MFP device. The user turns on the main power of the MFP device and then the backup control portion 102 performs the processing in step S208 in the safe mode.

The description of the processing in the safe mode is as follows. That is, the case in which the electric compatibility is not established includes two cases of the case in which an operating voltage of the main controller board is different from an operating voltage of the option board and the case in which the arrangement of the signal pin of the option connector is different from the arrangement assumed on the option board controller 10S side.

When the operating voltage of the main controller board is different from that of the option board, the over-current flows to the electric device in the MFP device, resulting in damage or breakage of the electric device. Further, if the arrangement of the signal pin of the option connector is different from that on the option board controller 105 side, a power line and a GND line are short-circuited or the two controllers drive the same signal pin. When the power and the GND are short-circuited, the over-current flows to the electric device or the like on the main controller board or the option board. Further, when the two controllers drive the same signal pin, one controller drives a high signal and another controller drives a low signal and then the over-current flows.

According to the embodiment, in order to prevent the above-mentioned problems in advance, in step S208, the backup control portion 102 performs the following operation of the signal pin and the power pin of the option connector set to the safe mode.

That is, first, an output signal pin for outputting the signal from the option board for the attachment to the main controller board is fixed to the GND (ground or earth) level after turning on the power. Secondly, an input signal pin for inputting the signal from the main controller board to the option board for the attachment is set to the high impedance so as to prevent the driving state of the signal. Thirdly, a power pin for supplying the power to the option board for the attachment of the main controller board is held to the GND level without increasing the voltage.

Under the above control operation, the MFP device is booted in step S210 without trouble or breakage of the electric device.

Strictly, the processing in steps S206 and S208 is executed as a part of the booting processing based on a booting program which will be described below (processing in steps S507 and S509 in FIG. 6 is similar, which will be described below).

The model name of the compatible MFP device shown in FIG. 4 can properly updated because the new type of MFP device can be later sold as a derivative product. The flowchart in FIG. 6 shows the operation and processing in attachment of the option board, including the updating processing.

Two differences exist between the processing in FIGS. 6 and 5. First, in step S502, downloaded from the printing server 124 to the backup control portion 102 is the latest board information of the option boards corresponding to the option I/F slot (option connector) of the MFP device and the slot for expanding the expansion board (expanding connector), and the latest board information is registered in the compatible determining table 1024. Secondly, in step S511, the board information of the RFID tag is updated based on the latest board information on the option board side.

The present invention is easily and quickly applied to the new type of MFP device by registering the latest board information downloaded from the printing server 124 in the compatible determining table 1024. The board information of the RFID tag on the option board is updated based on the board information, thereby using the same option board to the new type of MFP device.

Next, a detailed description is given of steps S206 to S209 in FIG. 5 and steps S507 to S510 in FIG. 6 with reference to the flowchart shown in FIG. 7.

The user turns on the main power of the MFP device (in step S701) and then the backup control portion 102 energizes and activates the I/O port except for that of the option connector (in step S702). The CPU 101 loads the booting program into the RAM 129 from the hard disk 116 (in step S703). The booting program is read from the RAM 129 and the booting processing is executed (in step S704).

Next, the backup control portion 102 sets the compatible YES/NO flag such as flags A to C shown in FIG. 9 to the compatible determining table 1024 (in step S705). Power supply permitting signals A_ON signal, B_ON signal, C_ON signal shown in FIG. 9 are output to the DC power unit 126 based on the compatible YES/NO flags (in step S706).

The DC power unit 126 issues, to the option board controller 105 and RAM controller 108, the power supply commands of VccA, VccB, and VccC shown in FIG. 9 based on the power supply permitting signals, thereby controlling the power supply to the option connectors 104 and 107 (in step S707). At this point in time, first, the power is fed to the electrically-compatible option connectors 104 and 107, the option board 103, and the option RAM board 106. However, the power is not fed to the option connector and the option boards which are not electrically compatible. The details of the power supply control in steps S705 to S707 is described below.

The CPU 101 sets the structure of the system which is changed in accordance with the addition of the option boards (in step S708), initializes parameters for I/O control (in step S709), and waits for jobs such as a printing job and a scanning job (in step S710). When the compatible YES/NO flag indicating it is not compatible is set in step S705, the CPU 101 initializes the parameters for I/O control and then displays such a message onto a display portion of the operation panel 122, thus to notify the user of the message in step S709.

For example, according to another method using a buzzer, a message may be notified, indicating that the option board is not electrically compatible with the option connector to which the option board is attached.

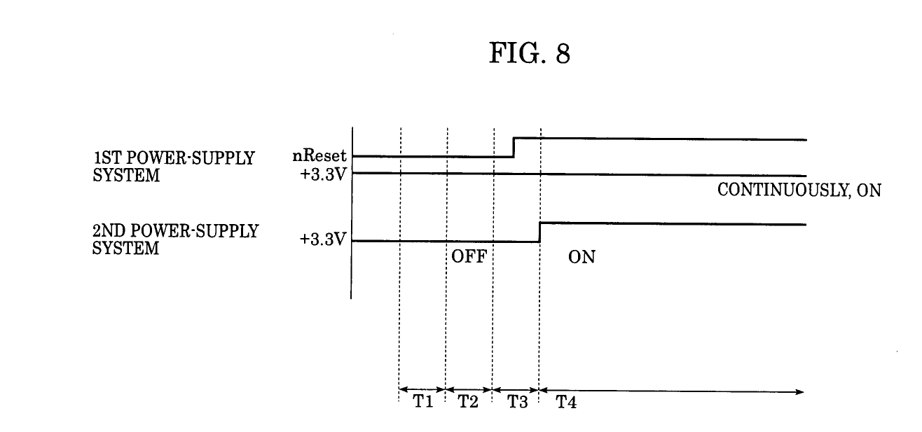

FIG. 8 is a time chart showing the power-supply control in steps S701 to S707.

A period T1 in FIG. 8 indicates a time lag to the time when the DC power unit 126 stably supplies the DC power after turning on the main power of the MFP device. A period T2 indicates a time for which an nRESET signal from the resetting IC 128 resets the system during the time for which the output from the crystal oscillator 127 is stable after feeding the DC power. A period T3 indicates a time for the processing in steps S701 to S707 in FIG. 7. A period T4 indicates a processing time after step S708 in FIG. 7.

Referring to FIG. 8, the power is not promptly supplied to the option connector and the option board after turning on the main power. There is the time lag to the time for actually supplying the power to the option connector and the option board after turning on the main power. Therefore, in the connecting state of the option connector and the option board which are not electrically compatible, the power supply operation for the option connector and the option board is controlled after turning on the main power (AC switch). Accordingly, it is possible to prevent the operation stop and erroneous operation of the MFP device and trouble and breakage of the electric device.

A first power-supply system shown in FIG. 8 includes the backup control portion 102, the readers/writers 104a and 107a, the NC 114, and the DC power unit 126 which receive the power voltage from the battery 125. A second power-supply system shown in FIG. 8 includes an electric device on the main controller board, except for the backup control portion 102, the readers/writers 104a and 107a, the NC 114, and the DC power unit 126.

FIG. 9 is a diagram showing the structure of a power supply control system of the backup control portion 102 and the DC power unit 126. The three option connectors are arranged as shown in FIG. 9.

Referring to FIG. 9, the readers/writers 104a, 107a, or 900 on the option connectors read the board information from the RFID tags on the option boards attached to the option connectors, and the board information is input to the backup control portion 102. The backup control portion 102 searches for the input board information on the compatible determining table 1024. When the input board information is registered in the compatible determining table 1024, it is determined that it is compatible. If the input board information is not registered in the compatible determining table 1024, it is determined that it is not compatible.

When it is determined that it is compatible, the backup control portion 102 sets on the compatible YES/NO flag corresponding to the option connector on the compatible determining table 1024. If it is determined that it is not compatible, the backup control portion 102 sets off the compatible YES/NO flag corresponding to the option connector and supplies flag signals A, B, and C corresponding to flag values to corresponding AND gates 1021, 1022, and 1023. In this case, when it is compatible, the flag signals A, B, and C at the high level are supplied. When it is not compatible, the flag signals A, B, and C at the low level are supplied. The nRESET signal is supplied to the AND gates 1021, 1022, and 1023.

For the period for which the nRESET signal is set at the high level at the timing shown in FIG. 8, the entire power supply permitting signals A_ON signal, B_ON signal, and C_ON signal output from the AND gates 1021, 1022, and 1023 are set at the low level indicating the prohibition of power supply. When the nRESET signal is set at the high level, the power supply permitting signals A_ON signal, B_ON signal, and C_ON signal output from the AND gates 1021, 1022, and 1023 are set at the level corresponding to the signal levels of the flag signals A, B, and C indicating YES/NO of the compatibility, respectively. That is, when it is compatible, the signal is set at the high level indicating the power supply permission. When it is not compatible, the signal is set at the low level indicating the prohibition of the power supply.

The DC power from the AC/DC converter 1262 is supplied to the DC power controller 1261 of the DC power unit 126. The DC power controller 1261 controls the DC power supply to the power pin of the corresponding option connector based on the power supply permitting signals A_ON signal, B_ON signal, and C_ON signal output from the AND gates 1021, 1022, and 1023.

That is, the DC power controller 1261 supplies the DC power (VccA, VccB, and VccC) to the corresponding option connectors when the power supply permitting signals A_ON signal, B_ON signal, and C_ON signal output from the AND gates 1021, 1022, and 1023 are at the high level for the power supply permission. The DC power controller 1261 does not supply the DC power (VccA, VccB, and VccC) to the corresponding option connectors when the power supply permitting signals A_ON signal, B_ON signal, and C_ON signal output from the AND gates 1021, 1022, and 1023 are set at the low level for the power supply prohibition.

The backup control portion 102 controls the power supply operation depending on the option connectors in accordance with YES/NO of the electric compatibility between the option connector and the option board attached thereto.

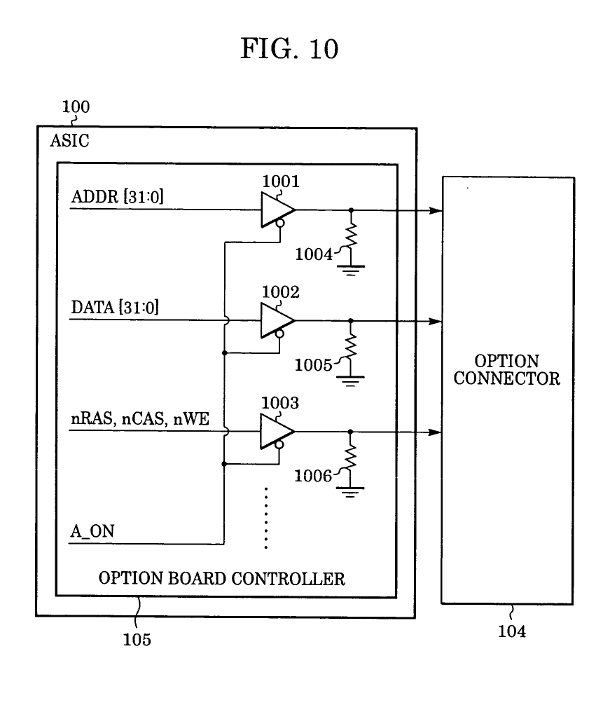

FIG. 10 is a diagram showing the structure of a drive control system for the signal pin other than the power supply pin of the option connector. Referring to FIG. 10, only the drive control system corresponding to the option connector 104 is shown and, however, the drive control system corresponding to another option connector is similarly structured.

Referring to FIG. 10, the option board controller 105 uses the power supply permitting signal A_ON signal as gate control signals of three-state buffers 1001, 1002, and 1003 for an address signal ADDR, a data signal, and access control signals (nRAS, nCAS, and nWE).

When there is no power supply to the option connector 104, the power supply permitting signal A_ON signal is at the low level, and therefore, the entire outputs of the three-state buffers 1001, 1002, and 1003 have the high impedance. The three-state buffers 1001, 1002, and 1003 are electrically disconnected to the option connector 104.

Pull-down resistors 1004, 1005, and 1006 set the signal pin of the option connector 104 at the low level, that is, the same level as that of GND. Even if the option boards which are not compatible with the option connector 104 are attached to the option connector 104, it is possible to prevent the operation stop and erroneous operation of the MFP device and the damage and breakage of the electric device.

As mentioned above, according to the embodiment, the RFID tags which record therein the board information are added to the option boards. The readers/writers are arranged on or near the option connector. The readers/writers read the board information from the RFID tags and determine the electric compatibility between the option board and the option connector. In other words, the electric compatibility between the option board and the option connector is determined without supplying the driving power to the option connector.

If the option board is not electrically compatible with the option connector, the power supply and signal drive to the option connector are prohibited to protect the MFP device against operation stoppage and erroneous operation and the electric device against damage and breakage.

At the place where the power is not supplied, the option board is set and then the electric device is moved to the actually available place.

Under the control operation, the shape of the option connector does not need the variation depending on the type of the option board so as to prevent the setting of the incompatible option board. Further, the physical shape of the option connector can be unified and thus various multiple effects are obtained, for example, the manufacturing costs are suppressed.

The present invention is not limited to the above-mentioned embodiment and can be applied to electric devices in addition to the MFP device, such as a personal computer, a printer, and a server device. Further, the present invention can be applied to a board which is always arranged, except for the option board and to a connector thereof.

The present invention is accomplished by supplying, to the system or apparatus, a storage medium (or a recording medium) which records program code of software for realizing functions of the embodiment and by then reading and executing the program code stored in the storage medium by a computer (or a CPU or MPU) of the system or apparatus.

In this case, the program code read-from the storage medium realizes the functions according to the embodiment and thus the storage medium which stores the program code structures the present invention. An operating system (OS) working on the computer executes a part or the entire actual processing based on an instruction of the program code, thereby realizing the functions according to the embodiment.

Further, the program code read from the storage medium is written to a memory of a function expansion card inserted in the computer or a function expansion unit connected to the computer. After that, a CPU of the function expansion card or function expansion unit executes a part or the entire actual processing based on the instruction of the program code, thereby realizing the functions according to the embodiment. When the present invention is applied to the storage medium, the storage medium stores therein the program code in accordance with the above-mentioned flowchart.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-392376 filed on Nov. 21, 2003, which is hereby incorporated by reference herein.

1. An electric device attachable to a board having an electric circuit and a memory, the electric device comprising:
a connector unit configured to connect to the board;
a first voltage-supply unit configured to supply a first voltage to operate the electric circuit;
a reading unit configured to read, from the memory, first determining information on whether or not the board is compatible with the electric device;
a determining unit configured to determine whether or not the board is compatible with the electric device based on the first determining information read by the reading unit; and
a control unit configured to control the first voltage-supply unit to supply the first voltage to the electric circuit responsive to the determining unit determining that the board is compatible with the electric device, and configured to prevent the first voltage-supply unit from supplying the first voltage to the electric circuit responsive to the determining unit determining that the board is not compatible with the electric device.

2. An electric device according to claim 1, wherein the reading unit is configured to read the first determining information from the memory in a non-contact state with the memory.

3. An electric device according to claim 2, further comprising:
a second voltage-supply unit configured to supply a second voltage to operate the reading unit,
wherein the reading unit supplies the second voltage to the memory, and reads the first determining information from the memory.

4. An electric device according to claim 1, further comprising a plurality of connector units, wherein the reading unit is arranged at the plurality of connector units.

5. An electric device according to claim 1, further comprising a notifying unit configured to issue a message indicating that the board is not compatible with the electric device responsive to the determining unit determining that the board is not compatible with the electric device.

6. An electric device according to claim 1, wherein the connector unit comprises a plurality of signal lines configured to interface with the board and having output states, and
wherein the control unit switches the output state of the plurality of signal lines responsive to the determining unit determining that the board is not compatible with the electric device.

7. An electric device according to claim 6, wherein the control unit switches the output states of the plurality of signal lines so as to prevent a current flow to the board responsive to the determining unit determining that the board is not compatible with the electric device.

8. An electric device according to claim 1, further comprising:
a holding unit configured to hold a second determining information on whether or not the board is compatible with the electric device,
wherein the determining unit determines whether or not the board is compatible with the electric device based on the first determining information and the second determining information.

9. An electric device according to claim 8, further comprising:
a receiving unit configured to receive the second determining information from an external device,
wherein the holding unit holds the second determining information received by the receiving unit.

10. An electric device according to claim 8, wherein the first determining information includes information about the board, and
wherein the second determining information includes information specifying a type of board connectable to the connector unit.

11. An electric device according to claim 8, wherein the first determining information includes information about a type of electric device to which the board is connectable to, and
the second determining information includes information about the electric device.

12. An electric device according to claim 8, wherein the first determining information includes information about a type of connector unit with which the board is connectable to, and
the second determining information includes information about the connector unit.

13. A control method for an electric device attachable to a board having an electric circuit and a memory, the control method comprising the following steps:
a reading step of reading, from the memory, first determining information on whether or not the board is compatible with the electric device;
a determining step of determining whether or not the board is compatible with the electric device based on the first determining information read in the reading step;
a first control step of controlling supply of a first voltage to operate the electric circuit responsive to determining that the board is compatible with the electric device in the determining step; and
a second control step of preventing the supply of the first voltage responsive to determining that the board is not compatible with the electric device in the determining step.

14. A control method of an electric device according to claim 13, wherein the reading step includes reading the first determining information in a non-contact state with the memory.

15. A control method of an electric device according to claim 13, further comprising a notifying step of issuing a message indicating that the board is not compatible with the electric device responsive to determining that the board is not compatible with the electric device in the determining step.

16. A control method of an electric device according to claim 13, wherein the second control step includes a switching step of switching output states of a plurality of signal lines interfacing the electric device with the board.

17. A control method of an electric device according to claim 16, wherein the second control step switching the output states of the plurality of signal lines so as to prevent a current flow to the board.

18. A control method of an electric device according to claim 13, further comprising:
a receiving step of receiving, from an external device, second determining information on whether or not the board is compatible with the electric device,
wherein the determining step includes determining whether or not the board is compatible with the electric device based on the first determining information and the second determining information.

19. A program stored on a recording medium and executable by a computer to perform the control method according to claim 13.
